(19) United States
(12) Patent Application Publication
(10) Pub. No.: US 2014/0029448 A1
(43) Pub. Date: Jan. 30, 2014

(54) Method And Apparatus For Improved Signal Processing In Wireless Networks

(71) Applicants: Krishna Balachandran, Morganville, NJ (US); Joseph H. Kang, Belle Mead, NJ (US); Kemal M. Karakayali, Highland Park, NJ (US); Kiran M. Rege, Marlboro, NJ (US)

(72) Inventors: Krishna Balachandran, Morganville, NJ (US); Joseph H. Kang, Belle Mead, NJ (US); Kemal M. Karakayali, Highland Park, NJ (US); Kiran M. Rege, Marlboro, NJ (US)

(21) Appl. No.: 13/559,014

(22) Filed: Jul. 26, 2012

(51) Int. Cl. H04W 24/02

(52) U.S. Cl. CPC H04W 24/02
USPC 370/252

(57) ABSTRACT

Various methods and devices are provided to address the need for improved cooperation-based signal processing. In a first method, network equipment determines (801) a set of dominant interferers for a wireless transmission and requests (802) user-plane data corresponding to each dominant interferer in the set of dominant interferers. The network equipment then processes (803) a received signal corresponding to the wireless transmission to extract the information transmitted. This processing uses at least some user-plane data corresponding to at least one dominant interferer in the set of dominant interferers.

### FIELD OF THE INVENTION

The present invention relates generally to communications and, in particular, to cooperation-based signal processing in wireless networks.

### BACKGROUND OF THE INVENTION

This section introduces aspects that may help facilitate a better understanding of the inventions. Accordingly, the statements of this section are to be read in this light and are not to be understood as admissions about what is prior art or what is not prior art.

Uplink performance of cellular networks, particularly those based on the Orthogonal Frequency Division Multiple Access (OFDMA) technology, is often limited by the interference caused by out-of-cell users. An effective way to mitigate this interference is via base-station cooperation; that is, received signals can be processed more effectively to reduce the level of interference (thus enhancing the quality of the desired signal) if base station receivers exchange user-plane and control-plane data about their received signals with each other. The base-stations that exchange such data to help one another form a cooperation cluster. Typically, larger cooperation clusters lead to greater suppression of out-of-cell interference. However, large cooperation clusters are often impractical because of the heavy backhaul traffic they engender and the demands they make on the signal processing capacity of the base-station receivers. As a consequence, in practice one is forced to work with relatively small cooperation clusters. Small cooperation clusters can, in principle, be configured statically or they can be formed in a dynamic manner in accordance with prevailing conditions. Small static clusters often confront serious performance issues, however, such as when the operating conditions include fluctuating shadowing and fading phenomena caused, for instance, by user mobility. As a result, a cooperation-based signal processing scheme may not be quite as effective as one would like it to be. Thus, new solutions and techniques that are able to improve cooperation-based signal processing schemes would meet a need and advance wireless communications generally.

### BRIEF DESCRIPTION OF THE DRAWINGS

FIG. 1 illustrates an example cellular network.

FIG. 2 illustrates a division of transmission resources into resource blocks.

FIG. 3 illustrates an example base coordination cluster.

FIG. 4 is a logic flow diagram of functionality performed by a base station in accordance with a first set of embodiments of the present invention.

FIG. 5 is a logic flow diagram of functionality performed by a base station to obtain long term measurements in accordance with one approach.

FIG. 6 is a logic flow diagram of functionality performed by a base station to obtain long term measurements in accordance with another approach.

FIG. 7 is a logic flow diagram of functionality performed by a base station in accordance with a second set of embodiments of the present invention.

FIG. 8 is a logic flow diagram of functionality performed in accordance with various embodiments of the present invention.

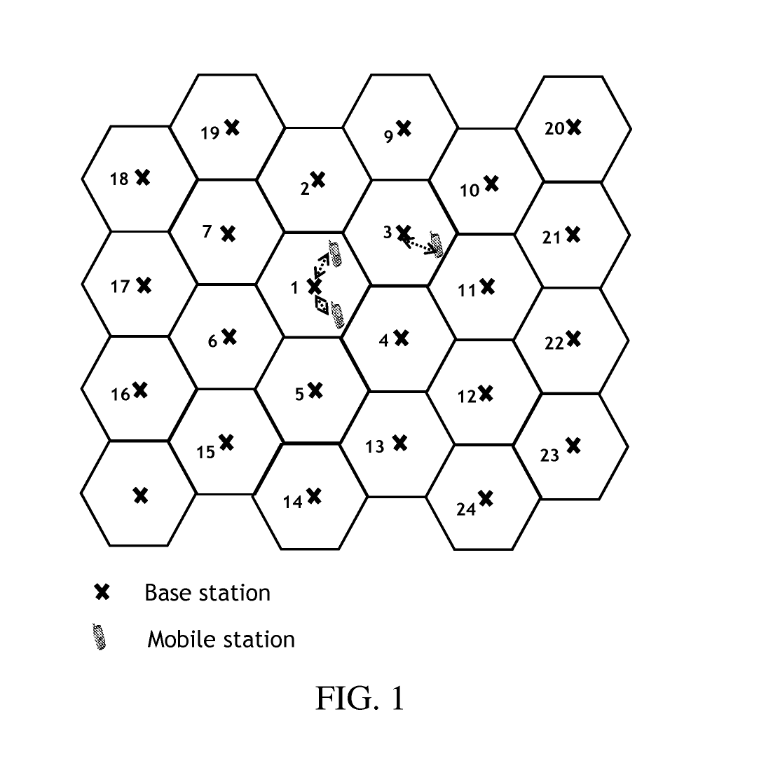

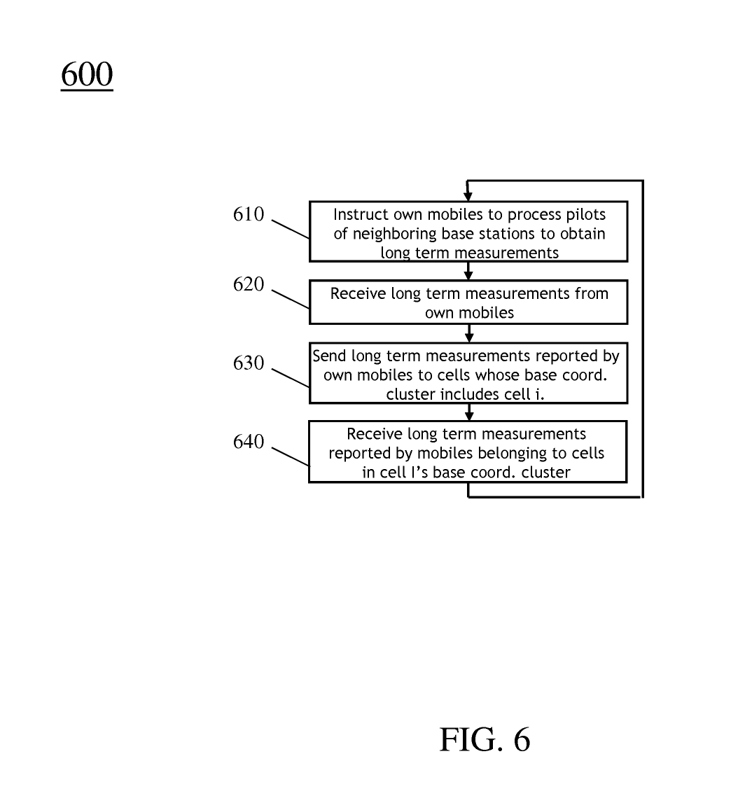

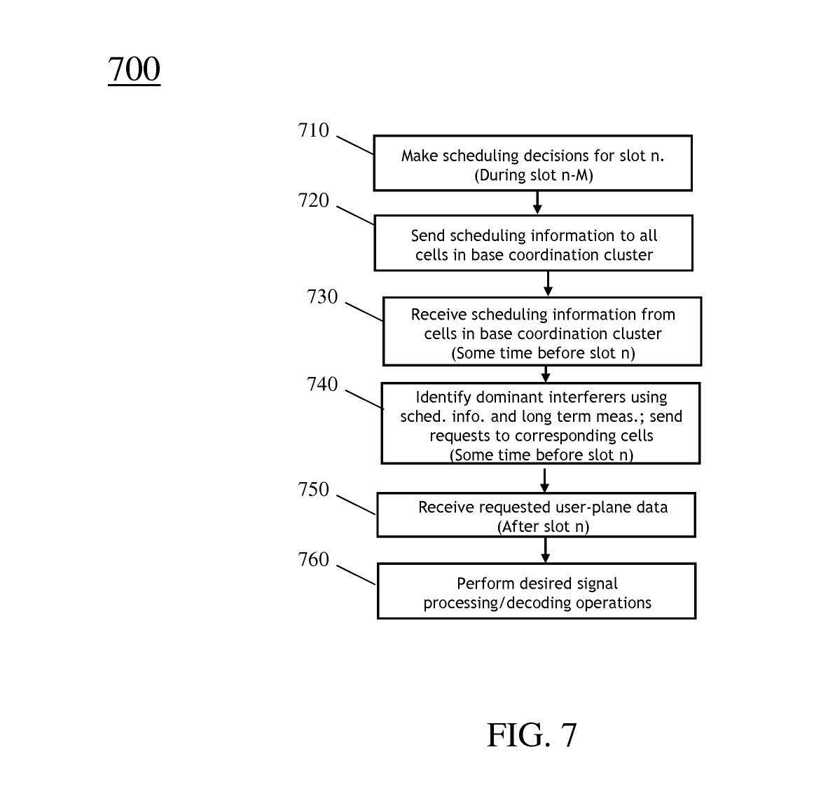

Specific embodiments of the present invention are disclosed below with reference to FIGS. 1-8. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

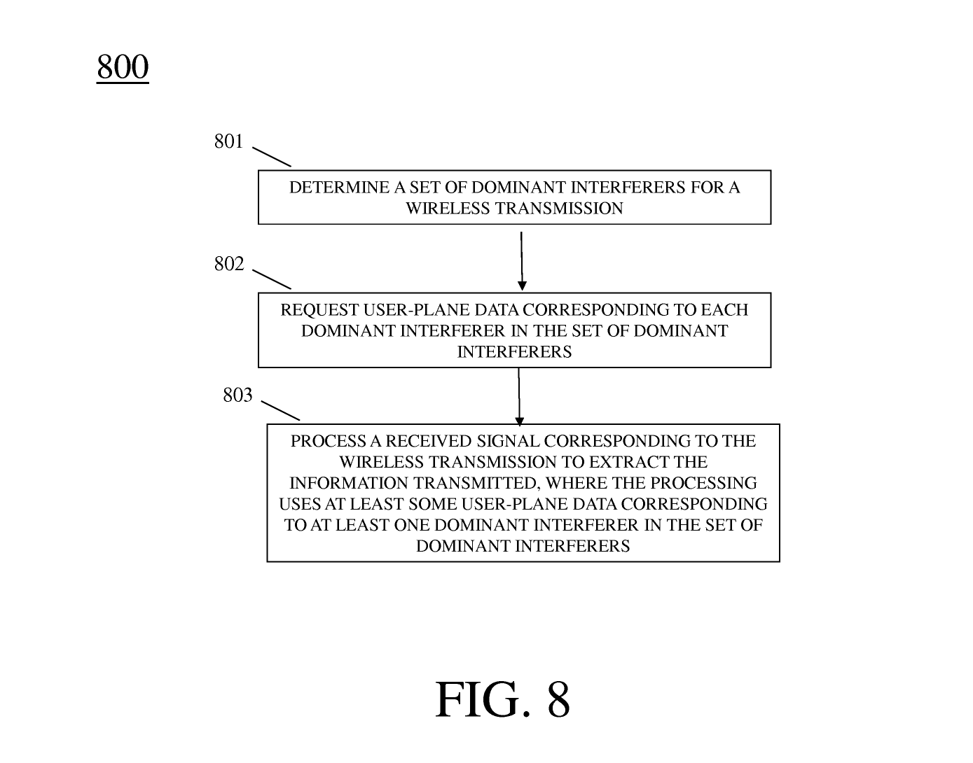

Various methods and devices are provided to address the need for improved cooperation-based signal processing. In a first method, depicted in logic flow 800 of FIG. 8, network equipment determines (801) a set of dominant interferers for a wireless transmission and requests (802) user-plane data corresponding to each dominant interferer in the set of dominant interferers. The network equipment then processes (803) a received signal corresponding to the wireless transmission to extract the information transmitted. This processing uses at least some user-plane data corresponding to at least one dominant interferer in the set of dominant interferers.

Many embodiments are provided in which the method above is modified. For example, in many embodiments the network equipment also sends scheduling information, corresponding to the wireless transmission, to equipment associated with at least one neighboring cell/sector. This may entail sending information corresponding to the wireless transmission that indicates a mobile station identifier, a resource block allocation, a modulation and coding scheme, a transmit power, and/or a Demodulation Reference Symbol sequence (DMRS).

In one group of embodiments, determining a set of dominant interferers for a wireless transmission includes determining a set of the strongest interferers, for an uplink resource block, each interferer of the set having a received signal strength estimate of at least a threshold value. In another group of embodiments, determining a set of dominant interferers includes determining long-term metrics for various wireless transmissions for use in determining strong interferers. The long-term metrics may include estimates of path loss and/or estimates of received signal strengths, for example. Depending on the embodiment, determining a set of dominant interferers may involve receiving from at least one neighboring cell/sector an indication of at least one interferer. For example, this indication may involve an indication of at least one downlink signal strength estimate.

In many embodiments, the network equipment requests user-plane data corresponding to each dominant interferer in the set of dominant interferers by indicating, for each dominant interferer, to the equipment associated with a cell/sector of that dominant interferer, an identity of the dominant interferer and a resource block corresponding to the wireless transmission. Having requested user-plane data, the network equipment may then receive user-plane data corresponding to at least one dominant interferer in the set of dominant interferers from equipment associated with a cell/sector of that dominant interferer. This user-plane data may include received signal samples or decoded information bits, depending on the embodiment.

A network equipment apparatus is also provided. The network equipment being configured to communicate with other equipment in the system and being operative to determine a set of dominant interferers for a wireless transmission, to request user-plane data corresponding to each dominant interferer in the set of dominant interferers, and to process a received signal corresponding to the wireless transmission to extract the information transmitted, wherein the processing uses at least some user-plane data corresponding to at least one dominant interferer in the set of dominant interferers. Many embodiments are provided in which this network equipment is modified. Examples of such embodiments can be found described above with respect to the first method.

Various network equipment architectures may be used to implement this signal processing, depending on the embodiment. For example, the network equipment may include a single device or multiple devices, such as one or more base stations and/or other network devices, the devices acting either individually to perform certain functionality or in a distributed manner (such as in a cloud computing architecture).

To provide a greater degree of detail in making and using various aspects of the present invention, a description of our approach to improving cooperation-based signal processing and a description of certain, quite specific, embodiments follows for the sake of example. FIGS. 1-7 are referenced in an attempt to illustrate some examples of specific embodiments of the present invention and/or how some specific embodiments may operate/perform.

Existing base-station cooperation methods typically use static clusters which, as mentioned earlier, have the following problem: If the static clusters are small, they are often faced with the possibility of missing out on the dominant interferers belonging to cells excluded from the cluster. Large, static clusters do not face this problem (at least not to the same level); however, they impose a heavy load on the backhaul links and the signal processing capacity of the base-station receivers. Thus, dynamically defined cooperation clusters, which are constructed “on-the-fly” based on some knowledge of existing conditions, are thought to provide an improved way of implementing base-station cooperation with (relatively) small clusters.

We assume user-centric cooperation clusters to describe several of the proposed embodiments. With user-centric clusters, in order to process a given user's signals, a cluster of cooperating cells is formed that is best suited to process that user's signals. This cluster typically comprises the cell associated with the user as well a few other cells associated with users whose signals constitute a dominant part of the interference suffered by the user of interest. Since, even for a given user, the identity and/or the nature of dominant interferers can vary from frame to frame, the make-up of the cooperation cluster associated with the user also changes over time.

As mentioned earlier, the capacity of the backhaul network and the signal processing capacity of the base-station receiver impose a limit on the size of the cooperation cluster. If these capacities limit the size of the cooperation cluster to include at most K other cells besides the cell associated with the user of interest, one needs to identify the K most dominant interferers whose transmissions overlap those of the user of interest (thus causing interference to the latter). Once these dominant interferers are identified, the corresponding cells (base-station receivers) can be notified so that they can send the requested user-plane data to the base-station receiver associated with the user of interest in a timely fashion. Several different approaches are envisioned to identify the cells to be included in the cooperation cluster associated with a user of interest.

Besides the limit on the size of the cooperation cluster imposed by the backhaul and processing capacity limits, there is yet another constraint that needs to be taken into account. This constraint relates to the maximum permissible delay in getting the user-plane data from the cooperating cells to the cell requesting the data (i.e., the one associated with the user of interest). This delay constraint often determines when decisions about the cells to be included in the cooperation cluster may be made, which in turn has an impact on what kind of measurements may be used to make these decisions. We present two main approaches for identifying the dominant interferers so that the corresponding cells can be included in the cooperation cluster for the user of interest.

The first of these approaches uses short term measurements, e.g., an estimate of the received signal strength associated with the interfering user that is computed by processing the corresponding demodulation reference signals. These reference signals are typically transmitted along with the data (in the same frame), so they are processed after the corresponding frame has been received. Since this processing and the subsequent messaging to request user-plane data from the cells included in the cooperation cluster takes some time, this approach should only be used when the delay constraint is relatively lax. On the plus side, though, this approach is more accurate in its ability to identify the dominant interferers than those based on long-term measurements. Consequently, it presents itself as an attractive scheme for cluster formation whenever the delay constraint is relatively lax.

The second approach uses longer-term measurements such as estimates of path loss associated with interfering users. There are two variants of this approach: In the first variant base-stations compute long-term estimates of the received signal strengths associated with potential interferers that belong to neighboring cells. These long-term estimates are computed by processing the special signals, e.g. sounding reference signals, that are periodically transmitted by mobile stations (users). In order to implement this variant of the second approach, cells to which these potential interferers belong need to keep the neighboring base-stations informed about the presence of these interferers and the transmission patterns of the special signals they periodically transmit.

The second variant involves measurement of the downlink reference signals (transmitted by base-stations) that mobile stations carry out and report to the base-stations (cells) to which they belong. This variant is based on the concept of reciprocity; that is, if the downlink reference signal transmitted by a neighboring base-station is found to be strong at a mobile station's receiver, that mobile station is likely to cause significant interference at that base-station. Thus, in accordance with this approach, each mobile station measures the received signal strength associated with the reference signals transmitted by the base-station associated with its own cell as well as those in its neighborhood. The mobile station processes these measurements to develop “long-term” signal strength estimates and reports them periodically to its base-station. The base-station compares these signal strength estimates with a threshold, and if it finds the estimate corresponding to a neighboring base-station to be above that threshold, it informs that neighboring base-station that the mobile station (that reported the estimate) is likely to be a strong interferer to the latter base-station. The message carrying this information also includes the signal strength estimate reported by the mobile station. Thus, in either case, i.e. whether the first or the second variant is implemented, each base-station is aware of potential interferers belonging to neighboring cells and the corresponding (long-term) signal strengths.

In the first approach as well as both variants of the second approach, whenever a base-station makes scheduling decisions for a given time-slot, it informs neighboring base-stations about the resource block allocations, the modulation and coding schemes being used over those resource blocks, the transmit powers associated with the corresponding transmissions, and so on. Consequently, using this information in combination with its own estimates of the signal strengths associated with potential interferers, a base-station can determine the identities of the most likely dominant interferers for each resource block. It can then send request messages to the corresponding cells (base-stations) to send the desired user-plane data whenever it becomes available. When the base-station receives this data, it can use it in combination with its locally available received signals to extract the data transmitted by the user(s) communicating with it.

Base-station cooperation has been shown to significantly improve uplink spectral efficiency and edge throughput, which are two key performance metrics from a service provider's perspective. However, given the constraints on the backhaul network, signal processing capacity and permissible delay, it is of vital importance to dynamically identify the (neighboring) cells where dominant interferers are located so that the corresponding user-plane data can be obtained in a timely fashion to carry out the appropriate signal processing steps.

Consider the example of a cellular network as depicted in FIG. 1. This example network has base stations with omni-directional antennas and hexagonal coverage areas. A base station as well as the coverage area associated with it is also referred to as a cell. Note that the assumption of omni-directional antennas and hexagonal, uniform coverage areas has been made only to simplify the description of several embodiments; however, the underlying concepts apply equally to networks in which base stations have sectorized antennas and/or non-uniform, non-hexagonal coverage areas. A focus of this approach is uplink interference mitigation using clustering methods for base station cooperation. To that end, we outline how uplink transmissions may be processed by base station receivers and how in various embodiments of the present invention base station cooperation is facilitated.

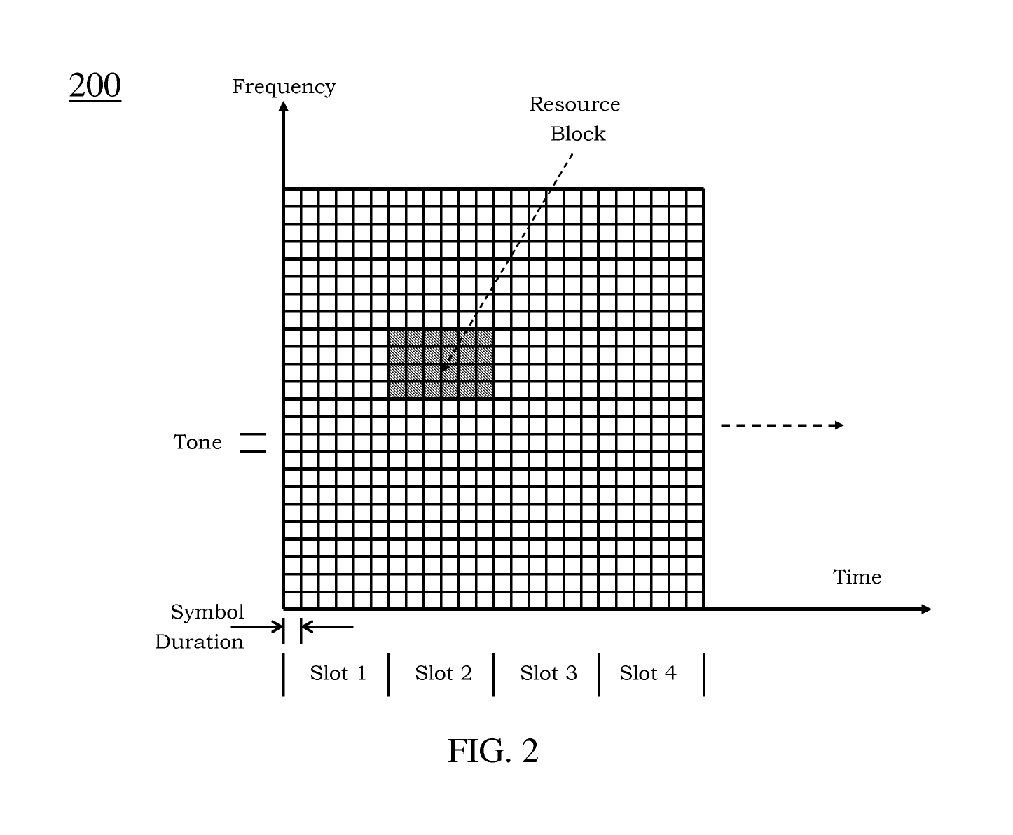

We assume slotted transmission and rough synchronization between all base stations and mobiles. We also assume a multi-carrier transmission system such as Orthogonal Frequency Division Multiple Access (OFDMA) wherein the available spectrum is divided into multiple carriers. A time slot comprises a fixed number of OFDMA “symbols.” Transmission resources are allocated by base stations to mobile stations communicating with them in units or “resource blocks.” A resource block comprises a fixed number of OFDMA sub-carriers (or tones) over one time slot. Diagram 200 of FIG. 2 illustrates this division of transmission resources into resource blocks. Two different mobile stations can potentially interfere with each other when they transmit over the same resource block.

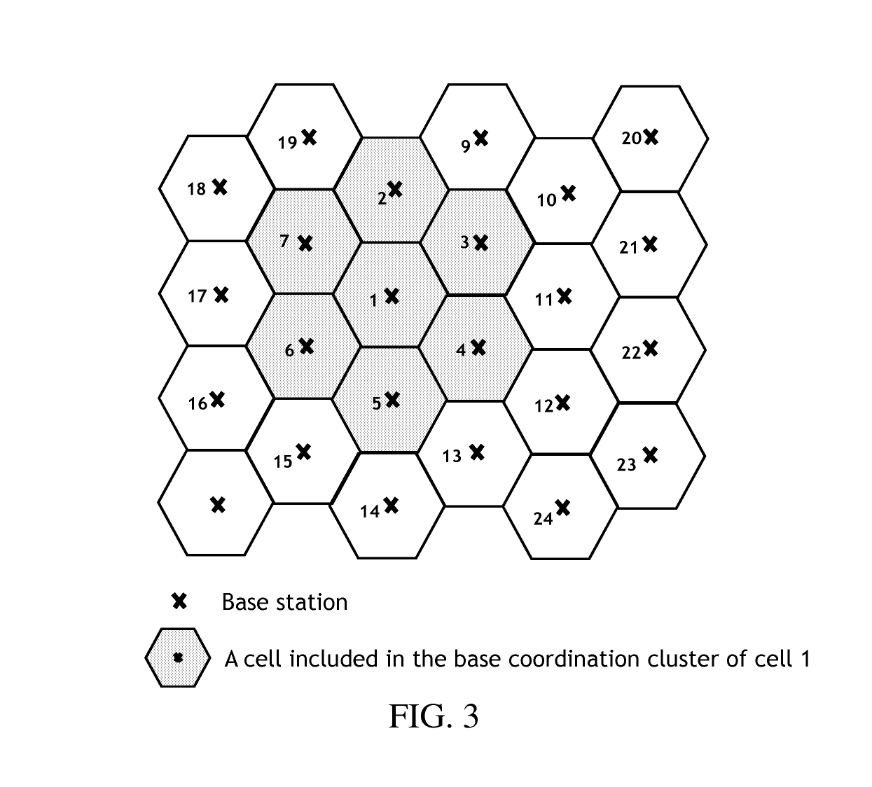

In accordance with various embodiments of the present invention, each cell has a base coordination cluster comprising some K cells in the neighborhood. Each cell's base coordination cluster is static and the cell is aware of its composition. Each cell also knows the identities of other cells whose base coordination clusters include it. For example, the base coordination cluster associated with cell 1 of FIG. 3 has six other cells besides cell 1. Thus, cell 1 knows that its base coordination cluster includes cells 2-7, and each of these cells (i.e., cells 2-7) is aware that they belong to the base coordination cluster associated with cell 1. We denote the base coordination cluster of cell k by B(k). Note that a given cell may be included in multiple base station clusters, B(k).

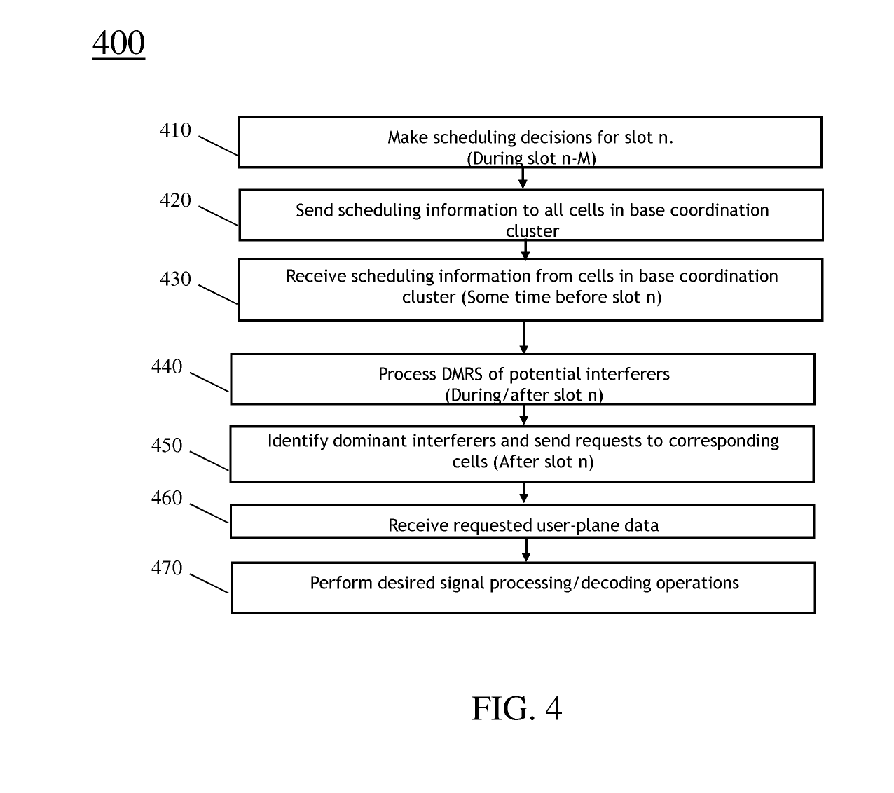

FIG. 4 is a logic flow diagram 400 of functionality performed by a base station in accordance with a first set of embodiments of the present invention. As in typical cellular systems supporting time-slotted, multi-carrier uplink transmissions, each base station makes scheduling decisions (410) for a given time slot, say slot n, some time before the beginning of that time slot. Let us assume that scheduling decisions for time slot n are made during time slot n-M, where M>1. Making scheduling decisions for a time slot involves selecting one or more mobile stations for uplink transmission during that time slot, allocating one or more resource blocks from that time slot to each of the selected mobiles, selecting a modulation and coding scheme and transmit power level for each of these allocations, and possibly selecting a Demodulation Reference Symbol sequence (DMRS) to be transmitted by the selected mobile stations along with their respective data transmissions. The base station conveys these scheduling decisions to the respective mobile stations via the downlink control channel during time slot n-L where M>L>1 so that those mobile stations are ready to transmit their respective data sequences during time slot n.

When a base station, say j, makes scheduling decisions for a time slot (say, n), it sends the corresponding scheduling information (420, 430) to all base stations whose base coordination clusters include base station j. The scheduling information for a slot includes the identifiers of the mobile stations selected for transmission during that slot, their resource block allocation, and details of the modulation and coding scheme, transmit power and DMRS to be used by the mobile stations over those resource blocks. Thus, all the base stations whose base coordination clusters include base station j are in possession of this scheduling information (for time slot n) before the beginning of that time slot.

Now consider the actions of a base station, say j, during time slot n. In order to avoid cumbersome descriptions, we refer to mobile stations belonging to cells included in base station j's base coordination cluster as its potential interferers. In accordance with this example embodiment, the receiver associated with base station j collects the received signal samples corresponding to DMRS transmissions by its potential interferers. If a resource block (during time slot n) is used by a mobile station communicating with base station j, the receiver correlates the received signal samples from that resource block which correspond to DMRS transmissions with the DMRS sequences used by base station j's potential interferers (440), and obtains estimates of the corresponding received signal strengths. (The process of correlating received signal samples corresponding to DMRS transmissions with the DMRS sequence used by a mobile station and using the resulting value to obtain an estimate of the corresponding received signal strength are well known to those familiar with the art.) Next, for each resource block used by a mobile station belonging to base station j during time slot n, the receiver identifies up to K strongest interferers based on the corresponding estimates of the received signal strength. Out of the interferers selected in this manner, it may discard those whose received signal strength estimates fall below a certain threshold value. We refer to the remaining ones as dominant interferers for the corresponding resource block (during time slot n.). The receiver then prepares a request message (450) for each of the cells included in its base coordination cluster listing the identifiers of the dominant interferers that belong to that cell and the indices of the resource blocks where those mobile stations are seen to be dominant interferers. These messages are then sent to their respective destinations. The receiver then waits a certain amount of time to receive (460) the requested user-plane data from cells belonging to its base coordination cluster.

The user-plane data takes different forms depending on the base station cooperation scheme being used. For instance, if the base station cooperation scheme involves “Joint Processing” (also known as “Network MIMO”), the user-plane data comprises received signal samples from the antennas associated with the cooperating base station If, on the other hand, the cooperation scheme is based on the “Network Interference Cancellation Engine (NICE),” the user-plane data comprises decoded information bits extracted by the cooperating base station if the latter has succeeded in decoding the transmissions of the mobile stations communicating with it. What user-plane data is thus transmitted by cooperating base station and how the requesting base station uses this data (470) will depend on the base station cooperation scheme being used.

Note that although the base coordination cluster can be large and static, by dynamically selecting the cells associated with a few dominant interferers the “effective size” of the coordination cluster is reduced substantially. Since only the cells associated with the dominant interferers send user-plane data to the requesting cell, the burden on the backhaul links as well as the signal processing components gets reduced to a manageable level. Note also that in the case of “NICE,” a base station can be made to send requests for user-plane data only if it fails in its first attempt at decoding the desired user's transmission (which it does on its own, using signals received at its own antennas.) This further reduces the load on the backhaul links.

One variant of embodiment 1 concerns the timing. Due to various implementation reasons, it is possible that scheduling information is not shared in advance of the transmission, but rather afterwards and perhaps only based on event triggers (e.g, if the baseline receiver processing does not lead to successful decoding of the transmitted packet). In this case, the out-of-cell DMRS decoding and dominant interferer identification will occur after receiving the scheduling information (which is provided after the packet transmission). Note that this is how it might work if we employ NICE to cancel previous HARQ transmissions of the same packet.

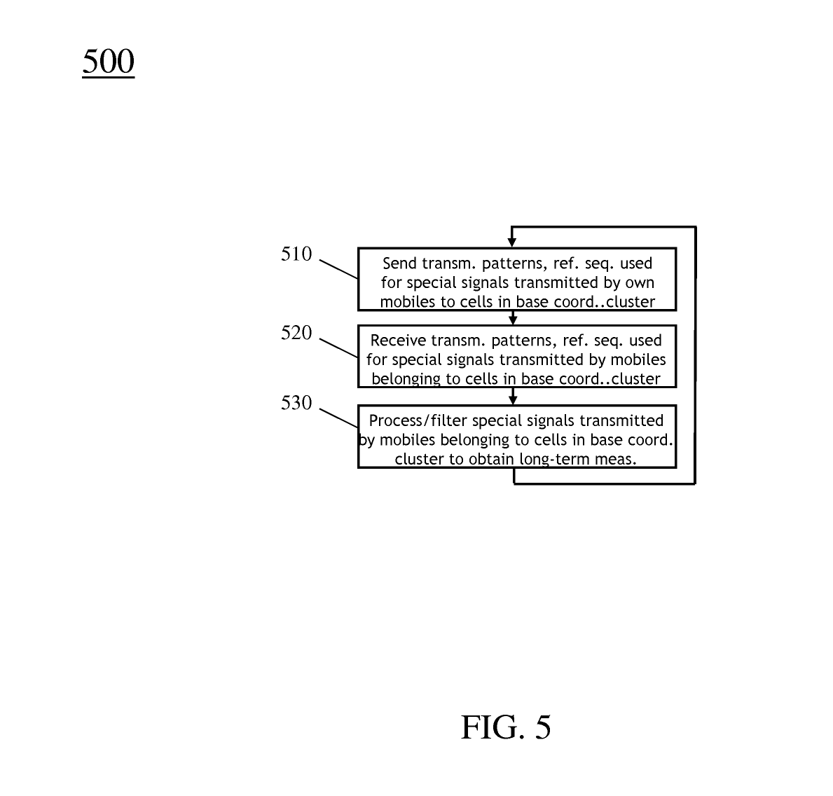

Logic flow diagrams 500, 600, 700 of FIGS. 5-7 depict functionality performed by a base station in accordance with a second set of embodiments of the present invention. In this second set of embodiments, identification of dominant interferers, which determine the effective cooperation cluster, is made on the basis of certain long-term metrics, such as path loss estimates. Since these metrics can be computed in the background and since the corresponding physical entities do not undergo rapid changes (in comparison to, say, Rayleigh fading), one does not have to wait for the completion of data transmission associated with a time slot to identify the dominant interferers corresponding to different resource blocks within that time slot.

As soon as a base station receives scheduling information for a particular time slot from all cells in its base coordination cluster, it can identify the dominant interferers for all resource blocks within that time slot using the long term metrics associated with the scheduled users located in cells belonging to the base coordination cluster. Once these dominant interferers are identified, requests for the corresponding user-plane data can be sent to their respective base stations well before the end of the corresponding time slot. As a consequence, base stations associated with the dominant interferers can send the associated user-plane data to the requesting base station as soon as the requested data becomes available. This avoids the “post-reception” delay incurred in the first set of embodiments which relates to the processing to obtain short-term measurements and sending requests to cells associated with dominant interferers. Thus, in scenarios where there is a tight latency requirement for the overall signal processing and decoding operations, this approach is likely to be preferred over those in the first set of embodiments (which are likely more accurate in identifying the dominant interferers and reducing backhaul load, however).

There are two variants of these embodiments based on the entity involved in carrying out the processing to obtain the desired long-term metrics. In the first variant, each base station carries out the processing to obtain the desired long-term metrics associated with potential interferers that belong to neighboring cells. Typically, in most cellular networks, each mobile station periodically transmits some special signals that are usually meant for the base station to which it is connected. For example, in networks based on the 3GPP LTE standard, mobile stations periodically transmit “Sounding Reference Signals” (SRS), which are used by their respective base stations to make scheduling decisions.

In this first variant, the base stations where a mobile station is likely to cause interference also process the special signals transmitted by the mobile station. In order to process the special signals transmitted by a mobile station, a base station needs to be aware of the identity of the mobile station, and the transmission pattern (which includes the time slots, resource blocks, etc. over which the special signals are transmitted) and the reference sequence associated with the special signals transmitted by the mobile station. Thus, in this first variant, whenever a mobile station becomes active and is assigned a transmission pattern and reference sequence for its special signals, the base station connected to it (referred to as the mobile station's parent base station) sends (510) a message to all base stations whose base coordination clusters include the parent base station. The message carries the identity of the mobile station, its parent base station, as well as details of the transmission pattern and reference sequence used by the mobile station for its special signals.

In short, the message makes the receiving base stations aware of the mobile station's presence and provides them with the information they would need to process the special signals transmitted by the latter. Similarly, when a mobile station becomes inactive (or leaves the cell) or the transmission pattern (or reference sequence) used by a mobile station changes, its parent base station sends a corresponding message to all base stations whose base coordination clusters include the parent base station. Thus, in this first variant, each base station is aware (520) of all mobile stations belonging to cells included in the base station's base coordination cluster as well as the transmission patterns and reference sequences used by them for the transmission of their respective special signals.

Using this information, each base station processes (530) the special signals transmitted by mobile stations belonging to cells in the base station's base coordination cluster, and obtains rough estimates of the corresponding received signal strengths. These rough estimates are then filtered to obtain estimates of the desired long-term metrics such as the corresponding path loss values. How to process the special signals transmitted by mobile stations and filter the results to obtain estimates of long-term metrics are well known in the art. At each base station, the process of obtaining estimates of these long-term metrics goes on in the background, independent of the actual data transmission and reception. In other words, at nearly all times each base station has an estimate of a long-term metric such as path loss, associated with each mobile station that is active within its base coordination cluster.

The second variant of these embodiments is based on the principle of reciprocity; that is, certain long-term metrics, such as path loss, are identical whether one measures them in the downlink direction or uplink direction. Accordingly, this variant gets mobile stations to carry out the desired measurements/estimation and then uses these measurements to identify the dominant interferers. In many cellular communication systems, base stations continually transmit certain pilot (reference) signals and mobile stations are equipped to process these signals to obtain estimates of the corresponding signal strengths. These signal strength estimates are used for various purposes, e.g. handoff decisions. Thus, in accordance with this second variant, each base station (say, i) instructs (610) mobile stations communicating with it to periodically process the pilot signals transmitted by it as well those transmitted by the base stations whose base coordination clusters include base station i. In some embodiments, mobile stations may forward neighborhood measurements to its serving cell according to existing procedures (e.g., if the received signal strength or signal-to-interference-plus-noise ratio is below a specific value or based on a measurement request by the serving cell).

The mobile stations process these pilot signals, filter them to obtain estimates of long-term metrics such as path loss, and report them periodically to their parent base station. In these reports, the mobile stations may include only those values that exceed a certain threshold θ. (That is, if the long-term metric associated with a base station is too weak, it may not be included in the report sent to the parent base station.) Each base station, say i, receives (620) such reports from mobile stations communicating with it, and periodically sends (630) a message to all base stations whose base coordination clusters include base station i. Measurement reports between base stations may additionally be event triggered (e.g., if a given measurement changes by X dB or more). Such a message, sent by base station i to base station j, includes the identifiers of all mobile stations communicating with base station i for which the latest reported value of the long-term metric associated with base station j was above the measurement threshold θ. The message also includes the values of the corresponding long-term measurements. In this manner, a base station receives (640) reports from all other base stations in its base coordination cluster so that at any time it has estimates of the long-term metrics associated with all mobile stations active in its base coordination cluster that are likely to cause significant interference.

If, for a given mobile station, a base station does not have an estimate of the long-term measurement, the base station assumes that that mobile station is unlikely to be a source of significant interference. Finally, note that it may be desirable to modulate the downlink measurements according to known downlink transmit powers (e.g., different base stations may employ different downlink transmit powers due to different coverage areas) and uplink transmit powers in order to get a more accurate representation of a given mobile's received signal strength at the desired base station. In this case, the measurements may be adapted (upward or downward according to downlink/uplink transmit powers of base stations and mobiles, respectively) and this metric would be the one compared to the measurement threshold θ and shared within the cluster.

It is easy to see that whether one implements the first or the second variant of these embodiments, at nearly all times each base station has an estimate of the long-term metric (e.g. path loss) for all mobile stations that are likely to cause significant interference. Note that this process of computing estimates of the long-term metric and reporting them to the appropriate base stations goes on in the background, independent of the actual data transmission.

The rest of the operation of a base station in accordance with the second set of embodiments is similar to that of the first set of embodiments. The main difference is that estimates of the long term measurement (rather than short-term measurement) are used in combination with scheduling information to identify the dominant interferers for each resource block within a time slot. Thus, when a base station, say i, makes scheduling decisions (710) for time slot n, it sends (720) the scheduling information to all the base stations whose base coordination clusters include base station i. As before, the scheduling information comprises the identifiers of the mobile stations selected for transmission during that slot, their resource block allocation, details of the modulation and coding scheme, transmit power and, possibly, the DMRS to be used by the mobile stations over those resource blocks.

When a base station receives (730) scheduling information for time slot n from all other base stations in its base coordination cluster, it knows which mobile stations are likely to be potential interferers for each resource block during that time slot and their respective transmit powers. It uses this information in combination with the corresponding estimates of the long-term metric (e.g. path loss) to identify (740) up to K strongest interferers for each resource block (within time slot n.) The interferers thus identified are referred to as the dominant interferers for the corresponding resource block (within time slot n.) Note that as mentioned earlier, if the base station does not have an estimate for the long-term measurement associated with a particular mobile station, the latter is not considered to be a significant source of interference. The base station then prepares a request message for each of the cells included in its base coordination cluster listing the identifiers of the dominant interferers that belong to that cell and the indices of the resource blocks where those mobile stations are seen to be dominant interferers. These messages are then sent to their respective destinations.

If base station j receives such a request message from base station i which lists some mobile stations communicating with the former as dominant interferers for certain resource blocks, it takes it as a request to send the user data associated with those resource blocks to base station i when it becomes available. Note that the process of identifying the dominant interferers for each resource block within time slot n, and sending request messages to the corresponding base stations takes place well before the completion of time slot n. As a result, a base station can send the requested user-plane data to the requesting base station as soon as it becomes available. This leads to significantly reduced wait times for the requesting base station; consequently, in scenarios with tight constraints on signal processing/decoding (750, 760) times, the second set of embodiments of the present invention is likely to be preferred.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as a magnetic disks or tapes, hard drives, or optically readable digital data storage media. The embodiments are also intended to cover computers programmed to perform said steps of methods described herein.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

What is claimed is:

1. A method, comprising:
determining a set of dominant interferers for a wireless transmission;
requesting user-plane data corresponding to each dominant interferer in the set of dominant interferers;
processing a received signal corresponding to the wireless transmission to extract the information transmitted, wherein the processing uses at least some user-plane data corresponding to at least one dominant interferer in the set of dominant interferers.

2. The method as recited in claim 1, further comprising sending scheduling information, corresponding to the wireless transmission, to equipment associated with at least one neighboring cell/sector.

3. The method as recited in claim 2, wherein sending scheduling information corresponding to the wireless transmission comprises
sending information corresponding to the wireless transmission that indicates at least one of a mobile station identifier, a resource block allocation, a modulation and coding scheme, a transmit power, and a Demodulation Reference Symbol sequence (DMRS).

4. The method as recited in claim 1, wherein determining a set of dominant interferers for a wireless transmission comprises
determining a set of the strongest interferers, for an uplink resource block, each interferer of the set having a received signal strength estimate of at least a threshold value.

5. The method as recited in claim 1, wherein determining a set of dominant interferers for a wireless transmission comprises
determining long-term metrics for various wireless transmissions for use in determining strong interferers.

6. The method as recited in claim 5, wherein the long-term metrics comprise at least one of estimates of path loss or estimates of received signal strengths.

7. The method as recited in claim 1, wherein determining a set of dominant interferers for a wireless transmission comprises
receiving from at least one neighboring cell/sector an indication of at least one interferer.

8. The method as recited in claim 7, wherein the indication of at least one interferer comprises an indication of at least one downlink signal strength estimate.

9. The method as recited in claim 1, wherein requesting user-plane data corresponding to each dominant interferer in the set of dominant interferers comprises
for each dominant interferer in the set of dominant interferers, indicating to the equipment associated with a cell/sector of that dominant interferer an identity of the dominant interferer and a resource block corresponding to the wireless transmission.

10. The method as recited in claim 1, further comprising
receiving user-plane data corresponding to at least one dominant interferer in the set of dominant interferers from equipment associated with a cell/sector of that dominant interferer.

11. The method as recited in claim 1, wherein user-plane data comprises at least one of received signal samples or decoded information bits.

12. An article of manufacture comprising a processor-readable storage medium storing one or more software programs which when executed by one or more processors performs the steps of the method of claim 1.

13. Network equipment in a communication system, the network equipment being configured to communicate with other equipment in the system, wherein the network equipment is operative
to determine a set of dominant interferers for a wireless transmission,
to request user-plane data corresponding to each dominant interferer in the set of dominant interferers, and
to process a received signal corresponding to the wireless transmission to extract the information transmitted, wherein the processing uses at least some user-plane data corresponding to at least one dominant interferer in the set of dominant interferers.

14. The network equipment as recited in claim 13, being further operative
to send scheduling information, corresponding to the wireless transmission, to equipment associated with at least one neighboring cell/sector.

15. The network equipment as recited in claim 14, wherein being operative to send scheduling information corresponding to the wireless transmission comprises
being operative to send information corresponding to the wireless transmission that indicates at least one of a mobile station identifier, a resource block allocation, a modulation and coding scheme, a transmit power, and a Demodulation Reference Symbol sequence (DMRS).

16. The network equipment as recited in claim 13, wherein being operative to determine a set of dominant interferers for a wireless transmission comprises
being operative to determine a set of the strongest interferers, for an uplink resource block, each interferer of the set having a received signal strength estimate of at least a threshold value.

17. The network equipment as recited in claim 13, wherein being operative to determine a set of dominant interferers for a wireless transmission comprises
being operative to determine long-term metrics for various wireless transmissions for use in determining strong interferers.

18. The network equipment as recited in claim 13, wherein being operative to determine a set of dominant interferers for a wireless transmission comprises
being operative to receive from at least one neighboring cell/sector an indication of at least one interferer.

19. The network equipment as recited in claim 13, wherein being operative to request user-plane data corresponding to each dominant interferer in the set of dominant interferers comprises
being operative to indicate, for each dominant interferer in the set of dominant interferers and to the equipment associated with a cell/sector of that dominant interferer, an identity of the dominant interferer and a resource block corresponding to the wireless transmission.

20. The network equipment as recited in claim 13, being further operative
to receive user-plane data corresponding to at least one dominant interferer in the set of dominant interferers from equipment associated with a cell/sector of that dominant interferer.
